(19) United States
(12) Patent Application Publication
(10) Pub. No.: US 2007/0203621 A1
(43) Pub. Date: Aug. 30, 2007

(54) Rail track evaluation system

(76) Inventors: Lioyd Haugen, Anacortes, WA (US); Giles Robert Humphrey, Anacortes, WA (US)

Correspondence Address: Lloyd Haugen, 6956 Carolina Street, Anacortes, WA, 98221, US

(21) Appl. No.: 10/995,023

(22) Filed: Nov. 23, 2004

(51) Int. Cl. G05D 1/00

(52) U.S. Cl. 701/19

(57) ABSTRACT

A method and apparatus to continuously detect, measure, and evaluate dynamic forces imposed upon moving rail cars due to variations in rail track condition. Acceleration sensing devices send dynamic load data to an on-board computer which determines whether such loads exceed pre-established allowable standards. Sensed dynamic loads are continuously loaded into computer memory. If allowable load standards are exceeded, the out-of-tolerance event together with train speed, time, and location coordinates of the event are recorded into permanent computer memory, together with a few minutes before and after the event. Depending on the severity of the imposed loads, a visual and/or sonic alarm may be sounded in the Locomotive. The recorded permanent memory data is transmitted to a Maintenance Facility for review, further action if needed, and historical record. Track data may also be downloaded by Maintenance Personnel directly from the On-board Microprocessor to a portable computer.

### BACKGROUND—FIELD OF THE INVENTION

This invention relates to railway safety, specifically to the sensing, evaluation, recording, and transmission of rail track condition data.

### BACKGROUND—FIELD OF THE INVENTION

The concurrent degradation of aging railroad tracks with the increasing desirability of train travel has produced a dangerous situation for rail traffic. New fast commuter trains are being built and some are being operated on old deteriorating tracks. However, to lay many thousands of miles of new track could make the cost of rail traffic prohibitive. The existing, and new tracks must therefore be continuously monitored to detect unsafe conditions or those that, while acceptable, are drifting toward an unsafe condition.

Track failure can be instantaneous or take place over a period of time. Washouts of the rails due to a flood or a landslide are examples of instantaneous failure. Slow settling of the rail ballast, thereby removing support for one or both of the tracks, is an example of a condition that, if not detected and corrected, could become catastrophic. Track failure is the main cause of derailment and derailment is the main cause of railroad disasters. It is therefore imperative that the condition of rail systems are continuously monitored, the gathered data evaluated, and corrective action taken where predetermined track “Allowable Acceleration” is exceeded. As used in this Application, the term Allowable Accelerations are those accelerations that if exceeded could result in a derailment. Conditions exceeding “Allowable”, therefore require immediate attention.

Several track-monitoring systems have been previously proposed by others but for a variety of reasons have not satisfied the needs of the railroad industry. Several systems (U.S. Pat. Nos. 5,956,664, 6,044,698, and 6,373,403 as examples) base their fault analysis principally on an allowable tilt of the Locomotive. However, these systems fail to consider the potential danger of equal subsidence of tracks, faulty track joints, and gauge anomalies, any of which could be disastrous in today's high-speed rail systems. U.S. Pat. No. 3,638,482 uses “measuring bogies” to mount data gathering equipment and does not consider acceleration, train speed nor train weight as important factors. U.S. Pat. No. 4,561,057 uses sensors to determine train speed and acceleration but not track condition. U.S. Pat. No. 5,754,449 incorporates sensors for “noxious gases”, “moisture in the atmosphere”, the “image of a geographic region” and other functions which have no relation to track condition.

Recent breakthroughs in the field of microprocessor electronics and “hardened” acceleration sensing devices now allow a physical arrangement and programming of off-the-shelf components to give the railroads the desired functionality while providing a high degree of reliability. This invention provides the unique blending of sensors, microprocessor capabilities, and communication equipment that allows the continuous gathering, analysis, reporting and storage of data for both immediate and long term use.

### OBJECTIVES AND ADVANTAGES

Accordingly, besides the objectives and advantages of the system briefly described above, several other objectives and advantages of our invention are:

(a) to provide continuous sensing and evaluation of rail track condition during normal loads and operation of a train, both loaded and unloaded, as it rolls over the track;

(b) to provide a continuous source of acceleration data from each track to a microprocessor located onboard the train (hereinafter referred to as the “On-Board Microprocessor”);

(c) to provide predetermined Allowable Accelerations which define the acceptable acceleration limits at various train speeds and loads;

(d) to provide a program, residing in the On-Board Microprocessor, that continuously collects and evaluates the received track condition related acceleration data and compares that data to the predetermined Allowable Accelerations relative to the speed of the train;

(e) to provide a means for the storage and subsequent retrieval of only that data which has recorded unacceptable track conditions (without the storage and retrieval of millions of hours of acceptable track data);

(f) to provide an onboard track evaluation system that requires no monitoring by the train Engineer or other onboard personnel;

(g) to provide means for instantaneous or delayed transmission of out-of -tolerance track condition data to a Maintenance Facility;

(h) to provide means for the review and for the storage of out-of-tolerance track condition data received by the Maintenance Facility;

(i) to provide a visual and audible alarm that informs the train Engineer that an allowable track condition has been exceeded and that he may receive instructions from the Maintenance Facility.

(j) to provide a rail track fault detection system that generate real-time hard data usable by centrally located personnel to make informed judgments relative to rail track conditions.

### DRAWING FIGURES

FIG. 1 shows the typical embodiment of the Rail Track Evaluation System.

FIG. 2 shows the Rail Track Evaluation System overall flow of system logic i.e. the flow of data and function from the various subsystems.

### REFERENCE NUMBERS IN DRAWINGS AND/OR DESCRIPTION

1. Accelerometer
2. Locomotive
3. On-Board Microprocessor
4. Communication System
5. Main Microprocessor (located at a Maintenance Facility)
6. Interconnecting Cable Assembly
7. Track Data Evaluation/Alarm System
8. Alarm Preprogramming System
9. Time/Speed/Location System
10. Global Position System (GPS)
11. Alarm Data Recording/Storage/Transmission System
12. Antenna
13. Audible/Visible Alarm System
14. Optional On-Board Data Retrieval Port

### SUMMARY

Two or more accelerometers, mounted perpendicularly to the track in the vertical and horizontal axes as far outboard as reasonably possible on the unsprung portion of the structure at each side of a locomotive, continuously generate acceleration data which reflects rail track condition in real time as the train rolls over it. This data is transmitted to an On-Board Microprocessor where it is compared with preprogrammed “Allowable Accelerations”. If measured accelerations exceed the preprogrammed parameters, the On-Board Microprocessor sounds an alarm, time/date/ and location stamps the data, and if so programmed, transmits the alarm and associated data to a central Maintenance Facility for appropriate action. In any case, the out-of-tolerance alarm and data is stored in the On-Board Microprocessor for subsequent downloading.

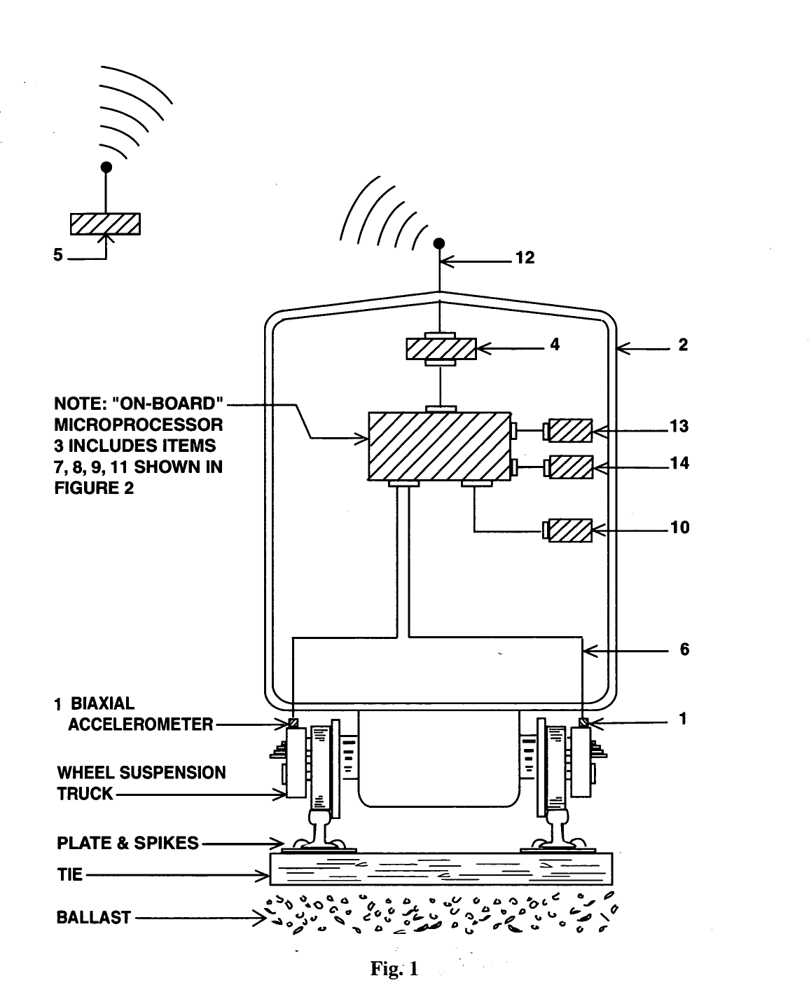

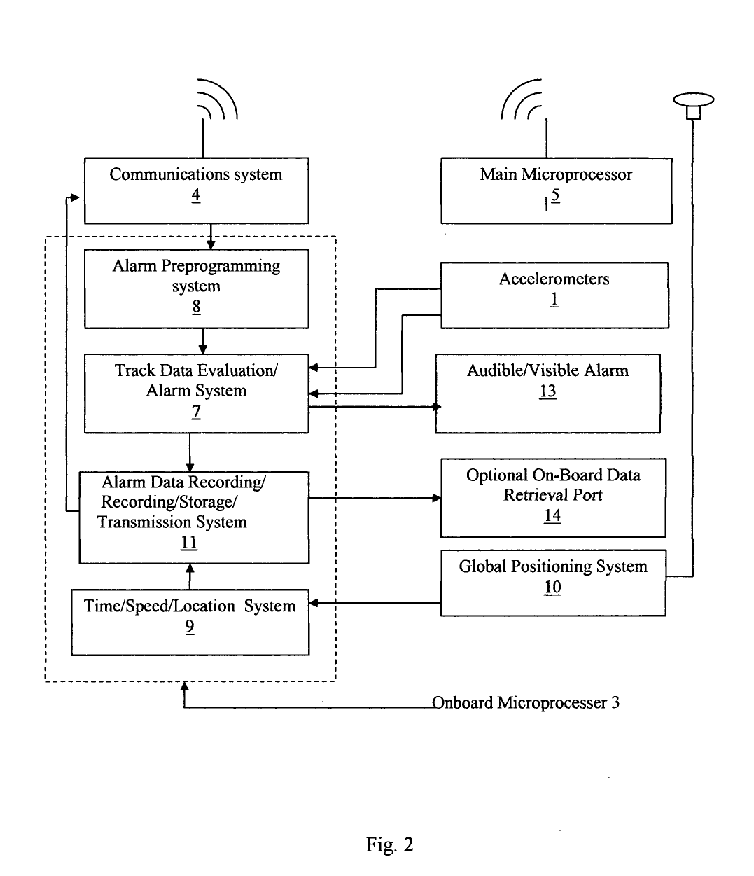

### DESCRIPTION—FIGS. 1 and 2

### FIG. 1

FIG. 1 shows a typical embodiment of the present invention. The invention physically consists of two or more Accelerometers 1 mounted as far outboard as possible onto a Locomotive 2, an On-Board Microprocessor 3 mounted in the cab or other convenient location on the Locomotive, a Time/Speed/Location System 9 utilizing an on-board Global Position System 10, a Communication System 4 that can transmit data thru the Antenna 12 to a Main Microprocessor 5 located at a Maintenance Facility or other rail management facility, an Audible/visible Alarm System 13 and interconnecting cables 6.

### FIG. 2

FIG. 2 illustrates the flow of rail condition data and the functional interrelationships of the systems that make up the Rail Track Evaluation System.

Operation

FIG. 2 depicts the flow of sensed track-condition data and the preprogrammed factors (referred to as “Systems”) that evaluate that data to determine whether remedial action is required to prevent a derailment. Note that only the On Board Microprocessor, the Main Microprocessor, the Track Sensing System (accelerometers), the GPS in the Time/ Speed/Location/System, the On-Board Audible/Visual Alarm, the On-Board Data Retrieval Port, and the Communication System are hardware. All other “Systems” are computer “programs” residing in an On-Board Microprocessor (located onboard the Locomotive) and a Main Microprocessor (located in the rail operator's Maintenance Facility).

Track Sensing System

The Track Sensing System 1 is functioning continuously during normal train operations scanning the condition of every foot of track traversed by said train. The Track Sensing System consists of two or more accelerometers that are capable of accurately sensing changes of velocity over time on at least two axes (vertical and horizontal) perpendicular to the track and associated cabling. These devices are securely mounted to the structure of the locomotive (or other convenient railcar) to sense the effects of the track condition on the locomotive wheels as they roll along the track. Data from the track condition sensing devices 1 is continuously sent thru cable assemblies to the Track Data Evaluation/Alarm System 7 for comparison to a preprogrammed “Allowable Accelerations” standard.

Alarm Preprogramming System

The Alarm Preprogramming System 8 resides in the Main Microprocessor located at a suitable Track Management, Train Traffic Control, or other facility that is equipped to transmit data to and receive data from, the On-Board Microprocessor 3 located on the Locomotive. The Main Microprocessor 5 is the source for the Allowable Accelerations that are programmed into the On-Board Microprocessor. The Allowable Accelerations are determined by qualified personel, taking into account such factors as acceptable acceleration force, acceleration direction, acceleration duration, train speed, known general track condition, class of locomotive, etc.

Track Data Evaluation/Alarm System

The Track Data Evaluation /Alarm System 7 receives data from the Track Sensing System 1 for analysis and further action if said analysis determines that track Allowable Accelerations have been exceeded. The Track Data Evaluation/ Alarm System compares the sensed accelerations and Locomotive speed with the previously entered Allowable Accelerations stored in the Alarm Preprogramming System 8. If the Allowable Accelerations have been exceeded, the track data is sent to the Alarm Data Recording and the Audio/Visual Alarm Systems

Time/Speed/Location System

The Time/Speed/Location System 9 is comprised of a basic Global Positioning System (GPS) 10, encompassing an electronic clock, a vehicle speed sensor and latitude and longitude coordinates which may be related to a precise location on the track. Time and speed may be obtained from individual equipment or be an integral part of the GPS. The Time/Speed/Location System 9 continuously feeds time, speed and location data into the Alarm Data Recording System thereby providing accurate recoverable time, speed and location data for any sensed track anomaly.

Alarm Data Recording/Storage/Transmission/Retrieval System

The Alarm Data Recording/Storage/Transmission/Retrieval System 11 upon receiving Alarm data from the Track Data /Evaluation/ Alarm System 7 combines that data together with a synchronous Time, Speed, Location stamp from the Time/Speed/Location System 9 and records the data together with a short period of time before and after the Alarm. The data resides in its memory until it is recorded into the Main Microprocessor 5 memory. If the train is equipped with wireless communication, the data can be transmitted for immediate review. If the train is not so equipped, the data may be stored and “downloaded” later to a portable PC using the optional On-board Data Retrieval Port 14 and then taken to the Main Microprocessor for analysis and corrective action if needed.

Audible/Visible Alarm System

The Audible/Visible Alarm System 13 will receive a signal from the Track Data Evaluation /Alarm System when an out-of-tolerance track condition has been sensed. The signal activates a flashing light and an audible sound producer located in the cab of the Locomotive. Two levels of alarm are provided: 1. “Monitor” —track condition is not now dangerous to train traffic but the Main Computer 5 will continue monitoring the faulty track location, and 2. “Critical” —a derailment risk exists so immediate action (such as closing the track to further traffic, reducing the allowable maximum train speed, rerouting other trains, emergency track repair, etc.) may be taken. The required action is determined and implemented by rail maintenance personnel after evaluation of the rail fault data on the Main Computer 5. The rail maintenance personnel may use the Main Computer 5 to remotely deactivate the Locomotive light/sound producer or this may be done locally by the train crew.

Communication System

The Communication System 4 consists of the equipment required for the Alarm Data Recording/Storage /Transmission System 11 to communicate with the Main Computer located in the Maintenance Facility while the train is rolling on a remote track. This equipment is by others and is not proprietary to the applicants.

### CONCLUSION, RAMIFICATION, AND SCOPE

Accordingly, the reader will see that the device disclosed in this invention enhances rail safety by monitoring and evaluating the condition of the track and that:
track monitoring is continuous (not intermittent or requiring manual activation);
allowable track conditions are preprogrammed into a Microprocessor thereby eliminating judgment calls by unqualified personnel.
out-of-tolerance track condition data is stored onboard the train in microprocessor memory for immediate transmission to a maintenance facility or for later downloading;
out-of-tolerance track condition data is also stored in a microprocessor at a maintenance facility for review;
if initial reporting of an out-of-tolerance condition does not require immediate track repair, as trains continue to pass over the faulty area additional data will be available to monitor and trend any further deterioration of the track;
decreased derailments will reduce railroad operators insurance costs;
knowledge of track condition may allow trains to operate at higher speeds thereby reducing operating costs;
the potential application of the invention is very broad and is applicable to almost any system wherein a device moves across a flat surface and data is needed relating to movements of the device relative to that surface.

Although the description given above contains many specificities, these should not be construed as limiting the scope of the invention, but as merely providing illustrations of some of the presently preferred embodiments of this invention. For example, the concept could be used on heavy-duty or precision tracked conveyer systems, “Maglev” type train systems, any form of automatic shock, vibration or movement sensing system, any form of automatic shock, vibration or movement sensing system/mitigation system, etc,

Thus, the scope of the invention should be determined by the appended claims and their legal equivalents, rather than by the examples given.

1. A method of sensing and storing railway track condition data by:
a. the use of two or more accelerometers rigidly mounted onto a wheel suspension “truck” of a Locomotive or other rail car to independently measure two or more axes of acceleration of such wheel suspension truck;
b. the transmission of measured truck acceleration data to a computer located onboard a Locomotive or other rail car for storage into memory.

2. The use of predetermined acceptable Locomotive or other rail car wheel suspension “truck” acceleration/train speed relationships that are programmed into a computer located onboard a Locomotive or other rail car to:
a. continuously compare predetermined acceptable truck acceleration/train speed parameters with measured truck acceleration/train speed data taken during train operation;
b. store into computer memory that measured truck acceleration/train speed data that does not conform to predetermined acceptable truck acceleration/train speed parameters for later access to and evaluation of a potentially faulty track condition;
c. store into computer memory that measured truck acceleration/train speed data that does not conform to the predetermined acceptable truck acceleration/train speed parameters for immediate access to and evaluation of a potentially faulty track condition if equipped with suitable communication equipment.

3. The use of computer memory to simultaneous store sensed wheel suspension “truck” accelerations, train speed, time, and train location, into the memory of a computer mounted in a Locomotive or rail car for evaluation of rail track condition and the location of potentially dangerous track.
